(19) United States
(12) Patent Application Publication
(10) Pub. No.: US 2022/0385217 A1
(43) Pub. Date: Dec. 1, 2022

(54) CONTROL MODULE AND METHOD FOR MANAGING THE END OF MOTOR MODE FOR A ROTARY ELECTRIC MACHINE

(71) Applicant: VALEO EQUIPEMENTS ELECTRIQUES MOTEUR, Creteil Cedex (FR)

(72) Inventors: Nanfang YANG, Creteil Cedex (FR); Wilfried CARREIRO, Creteil Cedex (FR); Luc KOBYLANSKI, Creteil Cedex (FR)

(73) Assignee: VALEO EQUIPEMENTS ELECTRIQUES MOTEUR, Creteil Cedex (FR)

(21) Appl. No.: 17/776,518

(22) PCT Filed: Nov. 10, 2020
(86) PCT No.: PCT/EP2020/081668

§ 371 Date: May 12, 2022

(30) Foreign Application Priority Data
Nov. 15, 2019 (FR) FR1912762

(51) Int. Cl. H02P 11/06; H02P 3/18

(52) U.S. Cl. CPC H02P 11/06; H02P 3/18

(57) ABSTRACT

A module for controlling a rotary electric machine for a motor vehicle includes a calculating program, a value of the rotor coil voltage Vrot, a resistance value of the rotor coil Rrot, a value of the rotor coil induction Lrot. The program estimates the rotor coil current Irot according to this formula: Irot[k]=Irot[k−1]+(Vrot[k−1]−Irot[k−1]×Rrot)/Lrot×Ts in which Irot[k−1] is the estimate of the rotor coil current previously calculated at time k−1 and Ts is the sampling time between the index k−1 and the index k. To switch from a motor mode to a neutral mode, the control module is configured to control a shorting of the phases of the stator after the estimated rotor coil current Irot is equal to a predetermined value.

### TECHNICAL FIELD OF THE INVENTION

The technical field of the invention is that of controlling rotary electric machines.

The present invention relates to a method for managing the end of motor torque for a rotary electric machine.

### TECHNOLOGICAL BACKGROUND OF THE INVENTION

In a manner known per se, a reversible electric machine can be coupled to the combustion engine, in particular via the accessory faceplate. This electric machine, commonly called a starter-alternator, is capable of operating in a generator mode in order to charge a vehicle battery and in a motor mode in order to provide the vehicle with torque.

Generator mode can be used in a regenerative braking function allowing the electric machine to deliver electrical energy to the battery in a braking phase. In particular, motor mode can be used in an automatic function for stopping and restarting the combustion engine depending on the traffic conditions (called the STT function, for stop-and-start function), a function for assisting with engine stalling, called the boost function, allowing the electric machine to occasionally assist the combustion engine in a phase of driving in combustion engine mode, and a coasting function, allowing the opening of the traction chain to be automated without explicit action from the driver so as to reduce engine speed or to stop it in order to minimize fuel consumption and polluting emissions. In addition, the motor mode can be used in electric vehicle mode in which the electric machine provides the torque required to move the vehicle forward without torque provided by the combustion engine.

In known machines, stopping the motor mode when a protection (thermal, time, or speed) is activated causes the switching elements of the inverter of the electric machine to open. The current contained in the stator is then sent back to the vehicle's onboard network, causing a torque jolt at the accessory faceplate and an overvoltage in the onboard network.

Therefore, there is a control unit comprising an algorithm for managing the torque when motor mode is stopped in order to avoid these jolts while passing through a neutral mode. The control unit transmits a torque instruction and a torque gradient according to a speed in order to bring the rotor current and then the stator voltage down to zero at this same speed.

To bring the rotor current down to zero in order to exit motor mode quickly, a rotor-voltage-to-zero instruction is imposed by performing slow demagnetization in a closed loop or equal to minus U_{B+} (U_{B+} being the voltage across the terminals of the machine), in order to impose a fast demagnetization that will lower the current in the rotor. In fast demagnetization, the coil of the rotor is supplied with power in reverse with respect to motor mode, which demagnetizes more quickly.

The demagnetization time is dependent on the rotor speed.

Next, once the rotor has been demagnetized, to avoid returning the current to the network, a short circuit is made between the phases of the stator, for example by closing the low-stage MOSFETs of the inverter/rectifier, for a predetermined duration of, for example, about 10 ms so that the residual current in the stator is lost through Joule heating in the coils of the stator.

However, this exit from motor mode often causes an oscillation in the torque and an overvoltage in the electrical network during the stator short circuit and the placing of the rotor at zero current for the transition to neutral mode. Indeed, it regularly happens that the shorting of the stator takes place while there is still current in the rotor.

One solution would be to wait the worst-case demagnetization time before shorting the stator. However, this will slow down the transition from motor mode to neutral mode, which may negatively affect the driver's experience.

Therefore, there is currently a trade-off between speed of the transition to neutral mode and overvoltage.

Another solution would be to have a measurement of the current in the induction coil of the rotor, for example using a resistor in series with the induction coil of the rotor and a unit for measuring the voltage in this resistor. However, such a resistor leads to Joule heating and reduces the efficiency of the machine. In addition, the demagnetization time is very lengthy because, at the end of demagnetization, the rotor current decreases very slowly.

There is therefore a need to decrease, or cancel out, the oscillation in the torque and an overvoltage in the electrical network for the transition from motor mode to neutral mode.

### SUMMARY OF THE INVENTION

The invention offers a solution to the problems mentioned above by considering the dynamics of the rotor to make it possible to have a better simulation of the rotor demagnetization slope and therefore to short the stator when the rotor has less current than in the prior art while avoiding an overly lengthy delay.

One aspect of the invention relates to a module for controlling a rotary electric machine for a motor vehicle comprising a rotor coil and phases of a stator supplied with power by an electrical network, the control module comprising a calculating program, an input comprising the voltage of the electrical network, a resistance value of the rotor coil, a value of the rotor coil induction and in that the program estimates an estimated rotor coil current according to this formula:

Irot[k]=Irot[k−1]+(Vrot[k−1]−Irot[k−1]×Rrot)/Lrot×Ts

in which:

Irot[k−1] is the estimate of the rotor coil current previously calculated at time k−1

Vrot [k−1] is the previous rotor coil voltage at time k−1

Ts is the sampling time between the index k−1 and the index k,

and in which, to switch the electric machine from a motor mode to a neutral mode, said control module is configured to control a placing of the phases of the stator at the same potential after the estimated rotor coil current is equal to a predetermined value, for example 0 amperes.

By virtue of the invention, by estimating the current of the rotor in question as the indicator for the final stage, it is possible to transition to neutral mode when the current in the rotor is almost zero. Thus, it is possible to decrease, or even eliminate, jolts and eliminate overvoltages by improving the reduction in the current in the rotor and the reduction in the stator to be as close to zero as possible at the same time. Indeed, the current and voltage peaks on the DC bus decrease in the transition from motor mode to neutral mode, the oscillations in the excitation and phase current are reduced or even disappear, and therefore the related torque jolts are lessened. In addition, the time taken to go from motor mode to neutral mode is reduced considerably.

Besides the features that have just been outlined in the previous paragraph, the control module according to one aspect of the invention may have one or more additional features from among the following, which are considered individually or in any technically feasible combination:

According to one embodiment, the control module for a rotary electric machine comprises a memory storing software instructions for implementing the calculation of the estimated rotor coil current and the rotor and stator commands as defined above.

According to one embodiment of the control module, to switch from a motor mode to a neutral mode, the control module is configured to produce a stator command as a function of the estimated rotor coil current.

According to one embodiment, the previously calculated rotor coil voltage is equal to a predetermined value, for example zero volts or minus eleven point three volts.

According to another embodiment, the control module comprises a network voltage input (Vdc) and the previously calculated rotor coil voltage is equal to 0 V or is calculated by the control module according to this formula:

Vrot[k−1]=−1×(Vdc[k−1]−Vdiode),

where Vdiode is a constant equal, for example, to zero point seven volts.

The invention also relates to a rotary electric machine comprising a control module according to the previous embodiment, comprising:

a rotor comprising an induction coil,

a stator comprising a winding having phases, and

a rotor control unit comprising:

a high-stage electronic switch connected between the input of the induction coil and the positive terminal of the network,

a low electronic switch between ground and the input of the induction coil,

a low output electronic switch between the output of the induction coil and ground,

a diode comprising a cathode connected to the positive terminal of the network and an anode connected to the output of the induction coil,

in which the rotor control unit may control, in the event of a motor-mode stop command, either according to a fast demagnetization instruction, the closing of the low electronic switch, the opening of the low output electronic switch and the opening of the high-stage electronic switch, or according to a slow demagnetization instruction, the closing of the low electronic switch, the closing of the low output electronic switch and the opening of the high-stage electronic switch,

in which, in the event of a fast demagnetization instruction, the previous rotor coil voltage is calculated according to the formula:

Vrot[k−1]=−1 ×(Vdc[k−1]−Vdiode), and

in the event of a slow demagnetization instruction, the rotor coil voltage is equal to zero.

According to one embodiment of the electric machine, the rotary electric machine comprises a temperature sensor in which the value of the rotor resistance is estimated as a function of the temperature measured by the temperature sensor.

For example, the value of the rotor resistance is according to this formula:

Rrot=R0(1+αv.ΔT)

where R0 is a resistance value of the coil at a predetermined temperature, ΔT(K) is the variation in temperature between the predetermined temperature and the temperature measured by the temperature sensor and αv is a predetermined isobaric volumetric expansion coefficient, equal, for example, to 0.0039 to 0.008 and advantageously 0.00396.

Specifically, the resistance of the rotor varies mainly according to the temperature of the rotor.

According to another embodiment of the electric machine, the value of the rotor resistance is a predetermined value.

Thus according to these two embodiments, to estimate the rotor current, either a value equivalent to the rotor coil resistance or an estimated value of the rotor resistance is calculated.

According to one embodiment of the electric machine, further comprising a rotor rotational speed sensor, the value of the rotor coil induction is estimated as a function of an operating point of the machine estimated on the basis of the estimated or instruction rotor torque and the rotational speed.

According to another embodiment of the electric machine, the control module estimates the rotational speed of the rotor and the value of the rotor coil induction is estimated as a function of an operating point of the machine estimated on the basis of the estimated or instruction rotor torque and the estimated rotational speed.

Specifically, the inductance of the rotor varies according to the magnetic saturation, and therefore an estimate of the inductance of the rotor is calculated in order to improve the accuracy of the estimated rotor coil current.

According to another embodiment, the value of the rotor coil induction (Lrot) is an equivalent value for the final stage.

According to one embodiment of the rotary electric machine, the control module comprises a transmission step for controlling the stator, for an instruction torque Tem[k] according to this formula: Tem[k]=Tem_0×(Irot[k]/Irot_0)\hat{ }2

where the rotor current Irot_0 is the estimated rotor current at the time when the control module receives the motor mode stop command and Tem_0 is the electromagnetic torque of the machine at the time when the control module receives the motor mode stop command instruction.

According to one embodiment of the rotary electric machine, the electric machine comprises a voltage converter comprising high electronic switches and low electronic switches connected to the phases of the stator and in that, when the control module receives a motor mode stop command for a motor mode activated previously, the control module transmits a stator command to modify the pulse-width modulation of the high-side electronic switches and of the low-side electronic switches according to the estimated rotor current, such that the lower the estimated rotor current, the more the pulse-width modulation is reduced in order to decrease the supply of power to the stator phases in terms of RMS voltage.

According to one example of this embodiment and of the preceding embodiment, the stator command is dependent on the calculated instruction torque Tem[k], for example the calculated instruction torque Tem[k].

According to one example, the electric machine comprises a stator control unit allowing the high- and low-side switches to be controlled by pulse-width modulation and the pulse-width modulation is parameterized according to the stator command.

Another aspect of the invention also relates to a method for stopping a motor mode of the rotary electric machine described above with or without the various embodiments, comprising:
a step of estimating the rotor coil current (Irot[k) according to this formula:

Irot[k]=Irot[k−1]+(Vrot[k−1]−Irot[k−1]×Rrot/Lrot×Ts
in which:
Irot[k−1] is the estimate of the rotor coil current previously calculated at time k−1
Vrot [k−1] is the previous rotor coil voltage at time k−1
Ts is the sampling time between the index k−1 and the index k,
a step of receiving an engine stop command, comprising:
   a demagnetization sub-step controlling the opening of the high-stage electronic switch and the closing of the low electronic switch, either according to a fast demagnetization instruction, by controlling the opening of the low output electronic switch, or according to a slow demagnetization instruction, by controlling the closing of the low output electronic switch, and
   a control sub-step for bringing the phases of the stator to the same potential after the estimated rotor coil current is equal to a predetermined value.

According to one embodiment of the preceding method, the method further comprises:
a step of calculating an instruction torque (Tem[k]) according to this formula:

Tem[k]=Tem_0×(Irot[k]/Irot_0)\hat{ }2
where the rotor current Irot_0 is the estimated rotor current at the time when the control module receives the motor mode stop command and Tem_0 is the electromagnetic torque of an instruction at the time when the control module receives the motor mode stop command instruction, and
a step of controlling the stator as a function of the instruction torque until the estimated rotor coil current is equal to a predetermined value.

The invention and its various applications will be understood better upon reading the following description and examining the accompanying figures.

### BRIEF DESCRIPTION OF THE FIGURES

The figures are presented by way of entirely non-limiting indication of the invention.

FIG. 1 is a schematic diagram of a stator electrical system SE;

FIG. 2 is an electrical schematic diagram of a rotor power supply system;

FIG. 3 schematically shows blocks in a diagram according to a first example of this embodiment;

FIG. 4 schematically shows blocks in a diagram according to a second example of this embodiment;

FIG. 5 schematically shows blocks in a diagram according to a third example of this embodiment;

FIG. 6A is a histogram graphically representing the network voltage Vdc, the electrical network current Idc, the actual rotor current lexc [A] and Iph [A] the current in a phase of the stator according to the prior art;

FIG. 6B is a histogram graphically representing the network voltage Vdc, the electrical network current Idc, the actual rotor current lexc [A] and Iph [A] the current in a phase of the stator of the electric machine according to the first example of the embodiment described above.

### DETAILED DESCRIPTION

The figures are presented by way of entirely non-limiting indication of the invention.

The electric machine is intended to be installed in a vehicle comprising an onboard electrical network connected to a battery.

The onboard network may be a 12 V, 24 V or 48 V network. The electric machine is coupled to a combustion engine in a manner known per se by a belt or chain system located on the accessory faceplate. In addition, the electric machine is capable of communicating with an engine computer using a LIN (Local Interconnect Network), CAN (Controller Area Network) or Ethernet communication protocol. The electric machine can operate in motor mode and can operate in alternator mode, also called generator mode. In the case where the machine can operate in alternator mode, the electric machine is a starter-alternator.

The rotary electric machine M comprises a stator having at least three phases U, V, W and three coils u, v, w wound on the stator.

According to one implementation of these embodiments, the rotary electric machine is a starter-alternator.

The starter-alternator comprises, in particular, an electrotechnical portion and a control module according to the invention which is described in more detail below. More precisely, the electrotechnical portion comprises an armature element and an inductor element. In one example, the armature is the stator, and the inductor is a rotor comprising an excitation coil, hereinafter called the rotor coil Lrotor. The stator comprises a number N of phases. In the example under consideration, the stator comprises the three phases U, V, W. In this example, the coils u, v, w are connected in star configuration and each comprise, at their output, the corresponding phase U, V, W, respectively. According to another example, the electric machine comprises six phases.

As a variant, the number N of phases may be equal to five for a five-phase machine, to six for a six-phase or double three-phase machine or to seven for a seven-phase machine. The phases of the stator may be coupled in delta or star configuration. A combination of delta and star coupling is also conceivable.

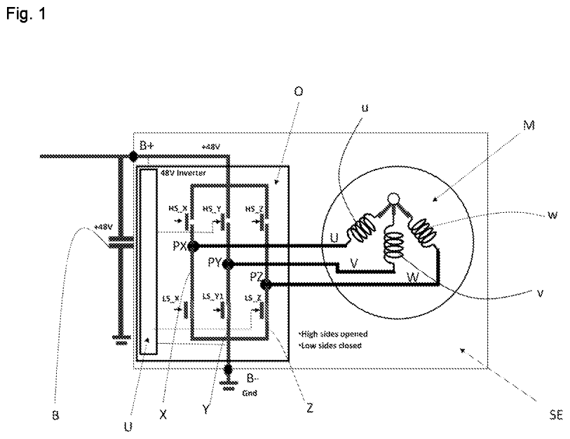

FIG. 1 is a schematic diagram of a stator electrical system SE. The electrical system SE comprises a first power supply terminal B+ and a second power supply terminal B− which are connected to a DC power source B, in the case of this example of 48 volts (but which may, for example, be 12 volts or 24 volts), for example a battery of a motor vehicle, allowing other items of electrical equipment (not shown) of the vehicle to be supplied with power via an onboard network.

The DC power source B may also comprise the battery of a motor vehicle and a capacitor bank connected in parallel with the battery of the vehicle. In this example, the second terminal B− is the ground of the electrical system SE.

The electrical system SE further comprises a voltage converter O for supplying the rotary electric machine M with power from said DC voltage source B.

The voltage converter O comprises a plurality of switching arms connected in parallel, the number of which is the same as that of the phases of the rotary electric machine M. In this case, the voltage converter O comprises a first arm X, a second arm Y and a third arm Z, but could comprise, for example, six thereof in the case of the example of a six-phase rotary electric machine.

Each arm X, Y, Z comprises a high-side switch HS_X, HS_Y, HS_Z, together forming a high group HS, and a low-side switch LS_X, LS_Y, LS_Z, together forming a low group LS. Each high-side and low-side switch of an arm X, Y, Z is connected to the other at a midpoint PX, PY, PZ.

In this example, each high-side or low-side switch is a metal-oxide-semiconductor field-effect transistor each comprising a flyback diode.

In this case, in this example, there is therefore, on the first arm X, a first high-side switch HS_X connected to a first low-side switch LS_X by a first midpoint PX, on the second arm Y, a second high-side switch HS_Y connected to a second low-side switch LS_Y by a second midpoint PY and a third high-side switch HS_Z, respectively connected to a third low-side switch LS_Z by a third midpoint PZ.

Each midpoint PX, PY, PZ is connected to at least one phase U, V, W of said rotary electric machine M, so in this case, in this example, the first midpoint PX to the phase U, the second midpoint PY to the phase V and the third midpoint Z to the phase W.

The voltage converter O further comprises a unit U for controlling the high-side HS X, HS_Y, HS_Z and low-side LS X, LS Y, LS_Z switches. Said control unit U therefore comprises, for each switch, an output connected to the control for the corresponding switch. To avoid overloading FIG. 1, only the connection between an output of the control unit U and the control for the third low-side switch LS_Z and another output of the control unit U and the control for the second high-side switch HS_Y have been shown.

The control unit U controls the switches of each arm X, Y, Z via pulse-width modulation (PWM).

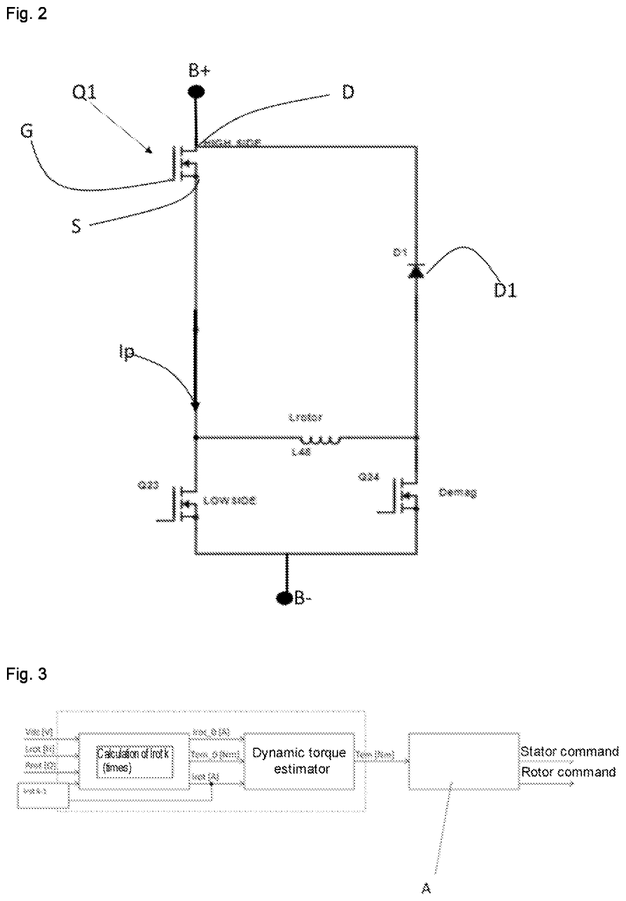

FIG. 2 is an electrical schematic diagram of a rotor power supply system.

The rotor power supply system comprises a power line for supplying a load with power, in this case the rotor coil Lrotor, from a voltage source, in this case the DC power source B.

Said power line comprises a main switch Q1 having a first main terminal D and a second main terminal S, between which a main current Ip is intended to pass.

The main switch Q1 further comprises a control terminal G for selectively placing the main switch Q1 in a closed, open or semi-closed state. In its semi-closed state the main switch Q1 is equivalent to a variable resistor connected between the first D and the second main terminal S controlled by the control terminal G. In this case, the main switch Q1 is a power transistor. More specifically, the power transistor is a metal-oxide-semiconductor field-effect transistor, also known by the acronym MOSFET, and in this case it is an enhancement MOSFET.

The power line is a high-side switch system 1 forming part of a switching arm of an electrical system.

The switching arm comprises a low-side switch system including a low-side switch Q23, also including first and second main terminals controlled by a control terminal.

The low-side switch Q23 and the main switch Q1 is a high-side switch Q1 and are connected at a midpoint.

The low-side switch Q23 is connected between the midpoint and a negative terminal B− which may be the ground of the vehicle.

The rotor coil Lrotor comprises a terminal connected at the midpoint.

The electrical system further comprises a low output, or demagnetization, electronic switch Q24, also comprising first and second main terminals, which is connected between the negative terminal and the other terminal of the excitation coil and is controlled by a control terminal.

The demagnetization electronic switch Q24 is controlled by the control module in saturation mode when the electric machine is in alternator mode or in motor mode or to demagnetize the excitation coil.

The low-side electronic switch Q23 allows, together with the demagnetization electronic switch Q24, controlled demagnetization of the coil Lrotor when the main switch Q1 is open.

The rotor power supply system further comprises, in this embodiment, a diode D1 between the terminal B+ and the second terminal of the rotor coil Lrotor.

This diode D1 allows fast demagnetization of the rotor by closing the low-side switch Q23 and opening the demagnetization switch Q24.

The control module comprises an excitation circuit incorporating a chopper for generating an excitation current which is injected into the rotor coil Lrotor.

The rotary electric machine comprises a motor mode, neutral mode and may comprise an alternator mode.

The control module further comprises a control circuit comprising a memory and, for example, a microcontroller.

The control module comprises a motor algorithm able to generate a stator command and a rotor command on the basis of a torque instruction to be applied to the rotary electric machine in order to place it in a motor mode. For example, following a request to activate a motor mode of the rotary electric machine, in particular when starting a motor vehicle combustion engine, said method comprises a step of applying an instruction torque and an instruction torque gradient transmitted by an engine computer of the motor vehicle.

In this embodiment, the control module can order the control unit U to control the switches of the voltage converter O so as to control the stator.

In another embodiment, the control module is the control unit U.

The control module can therefore also control the switches Q1, Q23, Q24 of the rotor power supply system.

The present invention aims to decrease, or cancel out, an oscillation in the torque and an overvoltage in the electrical network when switching from motor mode to neutral mode.

The control module comprises, in this embodiment, an input for measuring the voltage of the electrical network Vdc, corresponding to the voltage of the DC power source.

The control module comprises a resistance value of the rotor coil Rrot, and a value of the rotor coil induction Lrot.

FIG. 3 schematically shows blocks in a diagram according to a first example of this embodiment.

In the first embodiment in which the control module receives, as input, the resistance value of the rotor coil Rrot and the value of the rotor coil induction Lrot. Each of these two values can be a predetermined fixed value or a calculated value transmitted to the control module.

The control module comprises a memory storing software instructions for calculating an estimate of a rotor coil current (Irot [k).

The estimated rotor coil current is calculated according to this formula:

$$Iro t [ K ] = Iro t [ k - 1 ] + \frac{Vrot [ k - 1 ] - ( Irot * Rrot )}{Lrot} * T s$$

where Irot[k−1] is the estimate of the rotor coil current previously calculated at time k−1, Vrot[k−1] is the previous rotor coil voltage at time k−1

Ts is the sampling time between the index k−1 and the index k.

The electric machine comprises a motor mode and a neutral mode, and to transition from a motor mode to a neutral mode, said control module is configured to control a placing of the phases of the stator at the same potential after the estimated rotor coil current (Irot [k) is equal to a predetermined value, for example 0 amperes.

In this embodiment, the control module calculates the rotor coil voltage according to this formula:

Vrot[k−1]=−1×(Vdc[k−1]−Vdiode), where Vdiode is a constant equal, for example, to 0.7 V representing the voltage across the terminals of the diode D1.

According to one embodiment, the control module is configured to produce a stator command as a function of the estimated rotor current (Irot [K]).

In particular, the control module is configured, in this embodiment, to control the closing of the low-side switches LS_X, LS_Y, LS_Z and the opening of the high-side switches HS_X, HS_Y, HS_Z of the stator electrical system SE after the estimated rotor current (Irot [k) is equal to a predetermined value, for example 0 amperes. This grounds the phases of the stator. According to another embodiment, the control module is configured to control the opening of the low-side switches LS_X, LS_Y, LS_Z and the closing of the high-side switches HS_X, HS_Y, HS_Z of the stator electrical system SE after the estimated rotor current (Irot [K]) is equal to a predetermined value, for example 0 amperes. In this example, this sets the phases of the stator to the same potential that is at the terminal B+.

The closing of the low-side switches LS_X, LS_Y, LS_Z and the opening of the high-side switches HS_X, HS_Y, HS_Z of the stator electrical system SE can be controlled by a stator command sent to the control unit or directly by controlling the switches.

The invention thus makes it possible, following the request to stop motor mode, for the electric machine to be controlled according to an estimated rotor current Irot in order to decrease the current drawn before the switches (switching elements) of the inverter are completely opened. Estimating the current in this way makes it possible, first of all, to control the placing of the phases of the stator at the potential when the coil has a very low or zero rotor current, which avoids or reduces a shorting at the phases of the stator and therefore also oscillation in the torque and overvoltage. In addition, by being estimated and not real, it makes it possible to be faster and not to be dependent on a system for measuring or calculating the actual rotor current.

Indeed, the formula allows the estimated current to be close to or even equal to the estimated actual current over at least all of the start of the demagnetization of the rotor and, at the end of the demagnetization, the calculated estimated current is more quickly close to 0 amperes than the actual rotor current in order to decrease the transition time from motor mode to neutral mode.

The estimated current thus makes it possible both to avoid or reduce torque jolts and overvoltages in the onboard network of the motor vehicle and to be reliable and fast.

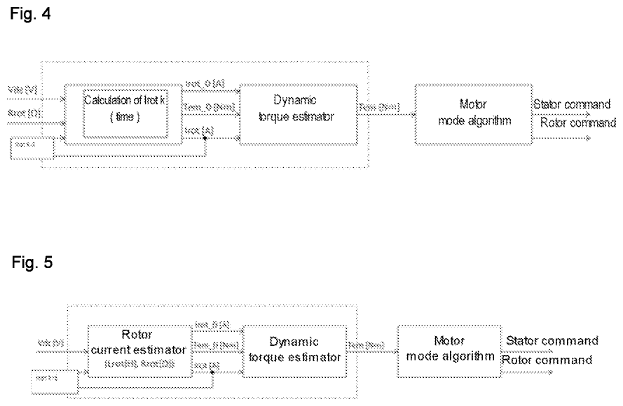

FIG. 4 schematically shows blocks in a diagram according to a second example of this embodiment.

The electric machine is identical to the electric machine described above except in that it further comprises a temperature sensor, for example mounted against a winding of the stator or against a bearing of the electric machine, and the value of the rotor resistance Rrot is estimated as a function of the temperature T measured by the temperature sensor. For example, the value of the rotor resistance Rrot is according to this formula: Rrot=R0(1+αv.ΔT)

Where R0 is a value of the resistance of the rotor coil at a predetermined temperature, for example 25° C. corresponding to 293.15, and ΔT is the variation in temperature between the predetermined temperature and the temperature measured by the temperature sensor, for example 125° C.−25° C.=100° C., and αv(K−1) is a predetermined isobaric volumetric expansion coefficient, for example equal to 0.00396.

R0 may, for example, be equal to 0.47 ohm and, for example at 120° C., the rotor coil resistance has a value of 0.65 ohm.

Thus, in this example, the control module estimates the rotor coil current more accurately since it takes into account the rise in the resistance of the rotor coil with temperature.

FIG. 5 schematically shows blocks in a diagram according to a third example of this embodiment.

The electric machine is identical to the electric machine described above except in that the electric machine further comprises a rotor position and rotational speed sensor, and the control module estimates the value of the rotor coil induction Lrot as a function of an operating point of the electric machine estimated on the basis of the estimated torque and the rotational speed of the rotor.

The angular position of the rotor may be measured by means of Hall-effect analog sensors and an associated magnetic target that rotates together with the rotor.

According to another embodiment (not shown), the control module is configured to switch from motor mode to neutral mode, a stator command according to the instruction torque and a predetermined torque gradient which is dependent on a rotational speed of the rotary electric machine, and the control module controls the placing of the phases of the stator at the same potential when the estimated rotor current Irot is equal to or lower than the predetermined value.

According to one example of this embodiment, the stator command is defined by an advance angle between a voltage of the stator and an electromotive force of the rotary electric machine, an opening angle of switching elements of an inverter, and an inverted voltage.

According to one implementation of this second embodiment, the higher the rotational speed of the rotary electric machine, the lower the predetermined torque gradient.

According to one implementation of these embodiments, the request to stop motor mode is generated following the expiration of a torque application time.

According to one implementation of these embodiments, the request to stop motor mode is generated following a temperature threshold being exceeded.

According to one implementation of these embodiments, the request to stop motor mode is generated following a rotational speed threshold for the rotary electric machine being exceeded.

According to one implementation of these embodiments, the rotor command is a value of an excitation current.

The invention also relates to a method for switching from a motor mode to a neutral mode of the electric machine.

The method relates to the torque control of the electric machine during an aborted combustion engine start-up phase.

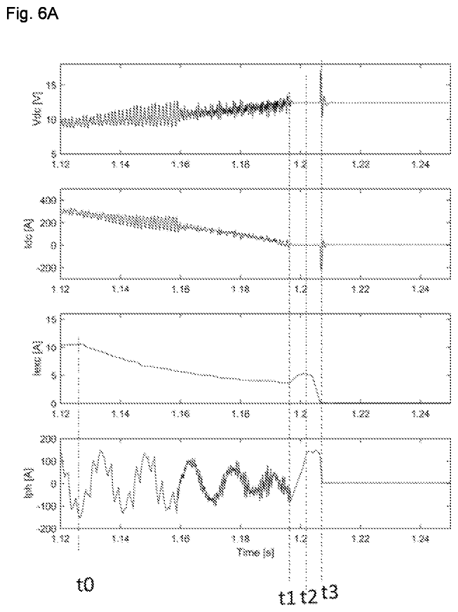

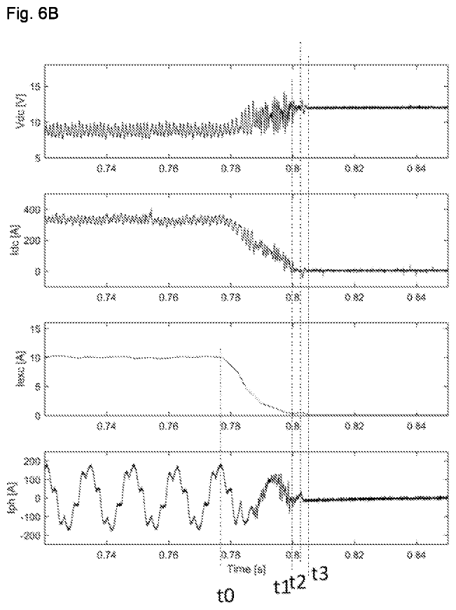

FIG. 6A is a histogram graphically representing the network voltage Vdc, the electrical network current Idc, the actual rotor current Iexc [A] and Iph [A] the current in a phase of the stator according to the prior art.

FIG. 6B is a histogram graphically representing the network voltage Vdc, the electrical network current Idc, the actual rotor current Iexc [A] and Iph [A] the current in a phase of the stator of the electric machine according to the first example of the embodiment described above.

The method according to the invention comprises a step of estimating the rotor coil current (Irot[k) according to the formula described above.

In each histogram, it is possible to see a time t0 (approximately 1.125 seconds for the histogram of FIG. 6A and 0.775 seconds for the histogram of FIG. 6B), during a request for the rotary electric machine to exit motor mode when starting a combustion engine of the motor vehicle, when the engine computer transmits a corresponding instruction to the electric machine via a communication bus, as well as an instruction torque, and an instruction gradient. This starting of the combustion engine occurs, for example, within the framework of the automatic function for stopping and restarting the combustion engine depending on the traffic conditions (called the STT function, for stop-and-start function).

The control module controls, at this time t0, in this embodiment, according to a fast demagnetization instruction, a rotor command and a stator command according to a calculation for an instruction torque (Tem[k]) according to this formula: Tem[k]=Tem_0×(Irot[k]/Irot_0)\hat{ }2 in order to decrease the excitation current lexc for the rotor coil and the current Iph in each phase of the stator. The electromagnetic torque of an instruction Tem_0 at the time when the control module receives the motor mode stop command instruction is recorded in order to calculate Tem[k] at this time t0.

It can be seen that the current lexc of the coil current decreases along a curve to a time t1. Time t1 (approximately at 1.195 seconds for the histogram of FIG. 6A and 0.8 seconds for the histogram of FIG. 6B).

At time t1, in the example of the prior art represented by the histogram of FIG. 6A, the actual rotor coil current lexc is approximately 5 amperes, whereas in the example of the embodiment of the invention represented by the histogram of FIG. 6B, the actual rotor coil current lexc is close to 0.5 amperes.

At time t0, the control module controls the fast demagnetization of the rotor by closing the low electronic switch Q23, opening the low output electronic switch Q24 and opening the high-stage electronic switch Q1 until a time t2.

At time t2, which corresponds to a step of controlling the shorting of the phases of the stator in the histogram of FIG. 6A and which corresponds to a step of controlling the placing of the phases of the stator at the same potential in the histogram of FIG. 6B according to the exemplary embodiment of the invention is after the estimated rotor coil current (Irot [k) is equal to 0. Specifically, since the rotor coil has no current or very little current left, the shorting of the phases of the stator causes a current peak in the network that is very small or even zero.

It can be seen from t2 that if the rotor coil Lrotor is carrying current, since the rotor is rotating and the phases of the stator are placed at the same potential, this delivers a current forming a short circuit and therefore a current peak in the histogram of FIG. 6A and a very small current in the histogram of FIG. 6B until a time t3.

In this period, it is possible to see, in the histogram of the prior art shown in FIG. 6A, an overvoltage Vdc which may cause disruption in the vehicle's network, while in the histogram of FIG. 6B, there is no or very little overvoltage because of the actual excitation current being close to 0 A at time t2.

Time t3 (at approximately 1.207 seconds for the histogram in FIG. 6A and 0.805 seconds for the histogram in FIG. 6B) corresponds to the transition of the electric machine to neutral mode. The machine has all of its bridges open. The rotor coil Lrotor is not being supplied with power and no longer returns stored energy.

The short-circuit period between t2 and t3 is 0.007 seconds for the histogram of FIG. 6A and 0.003 seconds for the histogram of FIG. 6B.

The short-circuit period is shorter according to the invention because of the smaller current in the rotor at time t1.

Unless indicated otherwise, one and the same element appearing in different figures has a single reference.

1. A module for controlling a rotary electric machine for a motor vehicle comprising a rotor coil (Lrotor) and phases (U, V, W) of a stator supplied with power by an electrical network, the control module comprising a calculating program, a value of the rotor coil voltage (Vrot), a resistance value of the rotor coil (Rrot), a value of the rotor coil induction (Lrot) and in that the program estimates an estimated rotor coil current (Irot [k) according to this formula: Irot[k]=Irot[k−1]+(Vrot[k−1]−Irot[k−1]×Rrot)/Lrot×Ts
in which:
Irot[k−1] is the estimate of the rotor coil current previously calculated at time k−1
Vrot [k−1] is the previous rotor coil voltage at time k−1
Ts is the sampling time between the index k−1 and the index k,
and in which, to switch the electric machine from a motor mode to a neutral mode, said control module is configured to control a placing of the phases of the stator at the same potential after the estimated rotor coil current (Irot [k) is equal to a predetermined value, for example 0 amperes.

2. The control module as claimed in claim 1, in which, to switch from a motor mode to a neutral mode, said control module is configured to produce a stator command as a function of the estimated rotor coil current (Irot [k).

3. The control module as claimed in claim 1, in which the control module comprises a network voltage input (Vdc) and in that the rotor coil voltage is equal to 0 V or is calculated by the control module according to this formula:
Vrot[k−1]=−1×(Vdc[k−1]−Vdiode),
where Vdiode is a constant equal, for example, to 0.7 V.

4. A rotary electric machine comprising a control module as claimed in claim 3, comprising:
a rotor comprising an induction coil,
a stator comprising a winding having phases, and
a rotor control unit comprising:
a high-stage electronic switch connected between the input of the induction coil and the positive terminal of the network,
a low electronic switch between ground and the input of the induction coil,
a low output electronic switch between the output of the induction coil and ground,
a diode comprising a cathode connected to the positive terminal of the network and an anode connected to the output of the induction coil,
in which the rotor control unit may control, in the event of a motor-mode stop command, either according to a fast demagnetization instruction, the closing of the low electronic switch, the opening of the low output electronic switch and the opening of the high-stage electronic switch, or according to a slow demagnetization instruction, the closing of the low electronic switch, the closing of the low output electronic switch and the opening of the high-stage electronic switch,
in which, in the event of a fast demagnetization instruction, the previous rotor coil voltage is calculated according to the formula:
Vrot[k−1]=−1×(Vdc[k−1]−Vdiode), and
in the event of a slow demagnetization instruction, the rotor coil voltage is equal to zero.

5. The rotary electric machine as claimed in claim 4, comprising a temperature sensor in which the value of the rotor resistance (Rrot) is estimated as a function of the temperature measured by the temperature sensor.

6. The rotary electric machine as claimed in claim 1, in which the value of the rotor coil induction (Lrot) is estimated as a function of an operating point of the machine estimated on the basis of the torque and speed.

7. The rotary electric machine as claimed in claim 1, in which the control module comprises a step of transmitting a stator command and a rotor command, an instruction torque Tem[k] according to this formula:
Tem[k]=Tem_0×(Irot[k]/Irot_0)\hat{ }2
where the rotor current Irot_0 is the estimated rotor current at the time when the control module receives the motor mode stop command and Tem_0 is the estimated electromagnetic torque of the machine at the time when the control module receives the motor mode stop command instruction until the estimated rotor coil current (Irot [k) is equal to a predetermined value.

8. The rotary electric machine as claimed in claim 1, comprising a voltage converter comprising high electronic switches and low electronic switches connected to the phases of the stator and in that, when the control module receives a motor mode stop command for a motor mode activated previously, the control module transmits a stator command to modify the pulse-width modulation of the high-side electronic switches and of the low-side electronic switches according to the estimated rotor current (Irot k), such that the lower the estimated rotor current (Irot k), the more the pulse-width modulation is reduced in order to decrease the supply of power to the stator phases in terms of RMS voltage.

9. A method for stopping a motor mode of a rotary electric machine for a motor vehicle as claimed in claim 1, comprising:
a step of estimating the rotor coil current (Irot[K]) according to this formula:
Irot[k]=Irot[k−1]+(Vrot[k−1]−Irot[k−1]×Rrot)/Lrot×Ts
in which:
Irot[k−1] is the estimate of the rotor coil current previously calculated at time k−1
Vrot [k−1] is the previous rotor coil voltage at time k−1
Ts is the sampling time between the index k−1 and the index k,
a step of receiving an engine stop command, comprising:
a demagnetization sub-step controlling the opening of the high-stage electronic switch and the closing of the low electronic switch, either according to a fast demagnetization instruction, by controlling the opening of the low output electronic switch, or according to a slow demagnetization instruction, by controlling the closing of the low output electronic switch, and
a control sub-step for bringing the phases of the stator to the same potential after the estimated rotor coil current (Irot [K]) is equal to a predetermined value.

10. The method for stopping a motor mode of a rotary electric machine for a motor vehicle as claimed in claim 9, further comprising:
a step of calculating an instruction torque (Tem[k]) according to this formula:
Tem[k]=Tem_0×(Irot[k]/Irot_0)\hat{ }2
where the rotor current Irot_0 is the estimated rotor current at the time when the control module receives the motor mode stop command and Tem_0 is the electromagnetic torque of an instruction at the time when the control module receives the motor mode stop command instruction, and
a step of controlling the rotor and the stator as a function of the instruction torque until the estimated rotor coil current is equal to a predetermined value.

11. The control module as claimed in claim 2, in which the control module comprises a network voltage input (Vdc) and in that the rotor coil voltage is equal to 0 V or is calculated by the control module according to this formula:
Vrot[k−1]=−1×(Vdc[k−1]−Vdiode),
where Vdiode is a constant equal, for example, to 0.7 V.

12. The rotary electric machine as claimed in claim 2, in which the value of the rotor coil induction (Lrot) is estimated as a function of an operating point of the machine estimated on the basis of the torque and speed.

13. The rotary electric machine as claimed in claim 2, in which the control module comprises a step of transmitting a stator command and a rotor command, an instruction torque Tem[k] according to this formula:
Tem[k]=Tem_0×(Irot[k]/Irot_0)\hat{ }2
where the rotor current Irot_0 is the estimated rotor current at the time when the control module receives the motor mode stop command and Tem_0 is the estimated electromagnetic torque of the machine at the time when the control module receives the motor mode stop command instruction until the estimated rotor coil current (Irot [k) is equal to a predetermined value.

14. The rotary electric machine as claimed in claim 2, comprising a voltage converter comprising high electronic switches and low electronic switches connected to the phases of the stator and in that, when the control module receives a motor mode stop command for a motor mode activated previously, the control module transmits a stator command to modify the pulse-width modulation of the high-side electronic switches and of the low-side electronic switches according to the estimated rotor current (Irot k), such that the lower the estimated rotor current (Irot k), the more the pulse-width modulation is reduced in order to decrease the supply of power to the stator phases in terms of RMS voltage.

15. The rotary electric machine as claimed in claim 3, in which the value of the rotor coil induction (Lrot) is estimated as a function of an operating point of the machine estimated on the basis of the torque and speed.

16. The rotary electric machine as claimed in claim 3, in which the control module comprises a step of transmitting a stator command and a rotor command, an instruction torque Tem[k] according to this formula:
Tem[k]=Tem_0×(Irot[k]/Irot_0)\hat{ }2
where the rotor current Irot_0 is the estimated rotor current at the time when the control module receives the motor mode stop command and Tem_0 is the estimated electromagnetic torque of the machine at the time when the control module receives the motor mode stop command instruction until the estimated rotor coil current (Irot [k) is equal to a predetermined value.

17. The rotary electric machine as claimed in claim 3, comprising a voltage converter comprising high electronic switches and low electronic switches connected to the phases of the stator and in that, when the control module receives a motor mode stop command for a motor mode activated previously, the control module transmits a stator command to modify the pulse-width modulation of the high-side electronic switches and of the low-side electronic switches according to the estimated rotor current (Irot k), such that the lower the estimated rotor current (Irot k), the more the pulse-width modulation is reduced in order to decrease the supply of power to the stator phases in terms of RMS voltage.

18. The rotary electric machine as claimed in claim 4, in which the value of the rotor coil induction (Lrot) is estimated as a function of an operating point of the machine estimated on the basis of the torque and speed.

19. The rotary electric machine as claimed in claim 4, in which the control module comprises a step of transmitting a stator command and a rotor command, an instruction torque Tem[k] according to this formula:
Tem[k]=Tem_0×(Irot[k]/Irot_0)\hat{ }2
where the rotor current Irot_0 is the estimated rotor current at the time when the control module receives the motor mode stop command and Tem_0 is the estimated electromagnetic torque of the machine at the time when the control module receives the motor mode stop command instruction until the estimated rotor coil current (Irot [k) is equal to a predetermined value.

20. The rotary electric machine as claimed in claim 4, comprising a voltage converter comprising high electronic switches and low electronic switches connected to the phases of the stator and in that, when the control module receives a motor mode stop command for a motor mode activated previously, the control module transmits a stator command to modify the pulse-width modulation of the high-side electronic switches and of the low-side electronic switches according to the estimated rotor current (Irot k), such that the lower the estimated rotor current (Irot k), the more the pulse-width modulation is reduced in order to decrease the supply of power to the stator phases in terms of RMS voltage.
